(19) United States
(12) Patent Application Publication
(10) Pub. No.: US 2024/0161006 A1
(43) Pub. Date: May 16, 2024

(54) SYSTEM AND METHOD FOR COORDINATING MULTIPLE AGENTS IN AN AGENT STOCHASTIC ENVIRONMENT

(71) Applicant: Telefonaktiebolaget LM Ericsson (publ), Stockholm (SE)

(72) Inventors: Kaushik DEY, Kolkata (IN); Perepu SATHEESH KUMAR, Chennai (IN)

(21) Appl. No.: 18/281,606

(22) PCT Filed: Mar. 15, 2021
(86) PCT No.: PCT/IN2021/050265

§ 371 Date: Sep. 12, 2023

(51) Int. Cl. G06N 20/00

(52) U.S. Cl. CPC G06N 20/00

(57) ABSTRACT

A method of performing multi-agent reinforcement learning in a system including a master node and a plurality of agents that execute actions on an environment based on respective local policies of the agents is provided. The method includes generating a ranking of the plurality of agents based on levels of variability of stochastic processes underlying the behavior of respective ones of the plurality of agents, sequentially updating the local policies of the agents in order based on the ranking, wherein the local policy of a selected agent is updated conditioned on an expected next state of at least one previously selected agent, simultaneously executing actions by agents based on their updated local policies, and updating the ranking of the plurality of agents in response to executing the actions.

### BACKGROUND

Reinforcement learning (RL) is a machine learning technique for controlling a software agent (or simply, “agent”) that operates in an environment. The agent makes observations of the environment and takes an action in the environment based on a policy which causes the state of the agent to change. The agent receives a reward based on the action, and updates the policy based on the reward and the new state. The objective of the agent is to find an optimal policy that maximizes the reward obtained from the environment.

RL assumes the underlying process that controls the state of the environment is stochastic and follows a Markov Decision Process (MDP) model. In a Markov Decision Process, it is assumed that the current state of the system depends only on the immediately preceding state and not on previous states. Often, the underlying model of a complex system is not known. In that case, it is possible to use model-less RL methods, such as Q-learning, SARSA (state-action-reward-state-action), etc.

The function that describes the policy is referred to as the policy function. The function that describes the operation of the system that generates rewards is referred to as the value function. In many cases the user must specify the value function. However, computing the value function is not easy for a system with many actions and states. Instead of specifying a value function, it is possible to use a deep neural network to approximate the value function. This approach is known as deep RL.

In deep RL, the network takes the network states as input and outputs a value referred to as a Q-value. Based on the output Q-value for each action, the agent will select an action which generates the highest reward. The network is updated based on the expected reward and the actual reward that was obtained. The network is trained when the agent reaches a terminal state or a requisite number of episodes has been completed. This approach is sometimes referred to as a Deep Q-Network (DQN) reinforcement learning.

In a multi-agent scenario, different agents may participate together and work to refine a policy either collaboratively or competitively.

### REFERENCES

[1] Zhang, Kaiqing, Zhuoran Yang, and Tamer Bas̨ar. “Multi-Agent Reinforcement Learning: A Selective Overview of Theories and Algorithms.” arXiv preprint arXiv:1911.10635 (2019).

[2] Buǫniu, Lucian, Robert Babus̆ka, and Bart De Schutter. “Multi-agent reinforcement learning: An overview.” In Innovations in multi-agent systems and applications-1, pp. 183-221. Springer, Berlin, Heidelberg, 2010.

[3] Sutton, Richard S., and Andrew G. Barto. Reinforcement learning: An introduction. MIT press, 2018.

[4] https://www.mit.edu/^{˜}dimitrib/Multiagent_Rollout.pdf

### SUMMARY

Some embodiments provide a method of performing multi-agent reinforcement learning in a system including a plurality of agents that execute actions on an environment based on respective local policies of the agents. The method includes estimating levels of variability of stochastic processes underlying the behavior of respective ones of the plurality of agents, selecting an agent having a lowest level of variability of its underlying stochastic process, instructing the selected agent to update its local policy, select an action based on its updated local policy, and generate an expected next state based on the selected action, and repeatedly selecting a next agent having a next lowest level of variability of its underlying stochastic process and instructing the next selected agent to update its local policy based on previously generated expected next states of previously selected agents, select an action based on its updated local policy, and generate an expected next state based on the selected action.

The method may further include initially generating a random ranking of the plurality of agents.

The method may further include instructing the agents to execute the selected actions.

The method may further include determining actual next states of the agents after executing the selected actions, comparing the actual next states of the agents after executing the selected actions to the expected next states of the agents, and generating a ranking of the agents by variability of their underlying stochastic processes based on the comparison of the actual next states of the agents after executing the selected actions to the expected next states of the agents.

The method may further include, for each agent, incrementing a counter when the expected next state of the agent matches the actual next state of the agent, wherein the ranking of the agents by variability of their underlying stochastic processes is based on values of their respective counters in ascending order.

The method may further include normalizing the counter values by dividing the counter values by a number of elapsed time steps since the counters were started.

The method may further include iteratively updating a ranking of the agents based on variability of their underlying stochastic processes, sequentially updating local policies of the agents, and simultaneously executing selected actions based on the updated local policies until the ranking of agents does not change between successive iterations.

The underlying stochastic processes of the agents may be Markov Decision Processes.

Some embodiments provide a method of performing multi-agent reinforcement learning in a system including a master node and a plurality of agents that execute actions on an environment based on respective local policies of the agents. The method includes generating a ranking of the plurality of agents based on levels of variability of stochastic processes underlying the behavior of respective ones of the plurality of agents, sequentially updating the local policies of the agents in order based on the ranking, wherein the local policy of a selected agent is updated conditioned on an expected next state of at least one previously selected agent, simultaneously executing actions by agents based on their updated local policies, and updating the ranking of the plurality of agents in response to executing the actions.

Updating the rankings of the agents may include updating a counter for each agent after executing the actions, wherein the counter for an agent is incremented when an actual next state of the agent after executing the action matches an expected next state of the agent.

The method may further include normalizing the counter values by dividing the counter values by a number of elapsed time steps since the counters were started.

Updating the local policy of an agent may include selecting an action based on an updated local policy of the agent, and generating an expected next state based on the selected action.

Some embodiments provide a master node for controlling multi-agent reinforcement learning configured to perform operations including estimating levels of variability of stochastic processes underlying the behavior of respective ones of the plurality of agents, selecting an agent having a lowest level of variability of its underlying stochastic process, instructing the selected agent to update its local policy, select an action based on its updated local policy, and generate an expected next state based on the selected action, and repeatedly selecting a next agent having a next lowest level of variability of its underlying stochastic process and instructing the next selected agent to update its local policy based on previously generated expected next states of previously selected agents, select an action based on its updated local policy, and generate an expected next state based on the selected action.

Some embodiments provide a master node for controlling multi-agent reinforcement learning according to some embodiments includes a processing circuit, and a memory coupled to the processing circuit, wherein the memory comprises computer readable program instructions that, when executed by the processing circuit, cause the computing device to perform operations of estimating levels of variability of stochastic processes underlying the behavior of respective ones of the plurality of agents, selecting an agent having a lowest level of variability of its underlying stochastic process, instructing the selected agent to update its local policy, select an action based on its updated local policy, and generate an expected next state based on the selected action, and repeatedly selecting a next agent having a next lowest level of variability of its underlying stochastic process and instructing the next selected agent to update its local policy based on previously generated expected next states of previously selected agents, select an action based on its updated local policy, and generate an expected next state based on the selected action.

Some embodiments provide a computer program comprising program code to be executed by processing circuitry of a computing device, whereby execution of the program code causes the computing device to perform operations of estimating levels of variability of stochastic processes underlying the behavior of respective ones of the plurality of agents, selecting an agent having a lowest level of variability of its underlying stochastic process, instructing the selected agent to update its local policy, select an action based on its updated local policy, and generate an expected next state based on the selected action, and repeatedly selecting a next agent having a next lowest level of variability of its underlying stochastic process and instructing the next selected agent to update its local policy based on previously generated expected next states of previously selected agents, select an action based on its updated local policy, and generate an expected next state based on the selected action.

A computer program product according to some embodiments includes a non-transitory storage medium including program code to be executed by processing circuitry of a computing device, whereby execution of the program code causes the computing device to perform operations of estimating levels of variability of stochastic processes underlying the behavior of respective ones of the plurality of agents, selecting an agent having a lowest level of variability of its underlying stochastic process, instructing the selected agent to update its local policy, select an action based on its updated local policy, and generate an expected next state based on the selected action, and repeatedly selecting a next agent having a next lowest level of variability of its underlying stochastic process and instructing the next selected agent to update its local policy based on previously generated expected next states of previously selected agents, select an action based on its updated local policy, and generate an expected next state based on the selected action.

Some embodiments provide a method of performing multi-agent reinforcement learning in a system including a master node and a plurality of agents that execute actions on an environment based on respective local policies of the agents. The method includes generating a ranking of the plurality of agents based on levels of variability of stochastic processes underlying the behavior of respective ones of the plurality of agents, sequentially selecting the agents in order based on the ranking and updating their local policies, wherein the local policy of a selected agent is updated conditioned on an expected next state of at least one previously selected agent, simultaneously executing actions by agents based on their updated local policies, and updating the ranking of the plurality of agents in response to executing the actions.

Updating the rankings of the agents may include updating a counter for each agent after executing the actions, wherein the counter for an agent is incremented when an actual next state of the agent after executing the action matches an expected next state of the agent.

The method may further include normalizing the counter values by dividing the counter values by a number of elapsed time steps since the counters were started.

Updating the local policy of an agent may include selecting an action based on an updated local policy of the agent, and generating an expected next state based on the selected action.

The method may further include initially generating a random ranking of the agents.

Some embodiments provide a computer program comprising program code to be executed by processing circuitry of a computing device, whereby execution of the program code causes the computing device to perform operations including generating a ranking of a plurality of agents in a multi-agent reinforcement learning system including a master node based on levels of variability of stochastic processes underlying the behavior of respective ones of the plurality of agents, sequentially selecting the agents in order based on the ranking and updating their local policies, wherein the local policy of a selected agent is updated conditioned on an expected next state of at least one previously selected agent, simultaneously executing actions by agents based on their updated local policies, and updating the ranking of the plurality of agents in response to executing the actions.

Some embodiments provide a computer program product comprising a non-transitory storage medium including program code to be executed by processing circuitry of a computing device, whereby execution of the program code causes the computing device to perform operations including generating a ranking of a plurality of agents in a multi-agent reinforcement learning system including a master node based on levels of variability of stochastic processes underlying the behavior of respective ones of the plurality of agents, sequentially selecting the agents in order based on the ranking and updating their local policies, wherein the local policy of a selected agent is updated conditioned on an expected next state of at least one previously selected agent, simultaneously executing actions by agents based on their updated local policies, and updating the ranking of the plurality of agents in response to executing the actions.

Some embodiments described herein provide a method in which policy execution is performed simultaneously, but policy computation is performed sequentially in order of agent reliability. Some embodiments described herein may be solved without reduced computational cost compared to conventional simultaneous methods. In addition, some embodiments account for the non-stationarity and credit assignment problems encountered by naïve decentralized methods.

### BRIEF DESCRIPTION OF THE DRAWINGS

FIG. 1 illustrates a system including a plurality of agents operating in an environment according to some embodiments.

FIG. 2 illustrates operations of a multi-agent reinforcement learning system according to some embodiments.

FIG. 3 illustrates operations of an master node in a multi-agent reinforcement learning system according to some embodiments.

FIG. 4 illustrates operations of a multi-agent reinforcement learning system according to some embodiments.

FIG. 5 illustrates components of an agent device according to some embodiments.

FIG. 6 illustrates components of a cloud agent device according to some embodiments.

### DESCRIPTION OF EMBODIMENTS

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

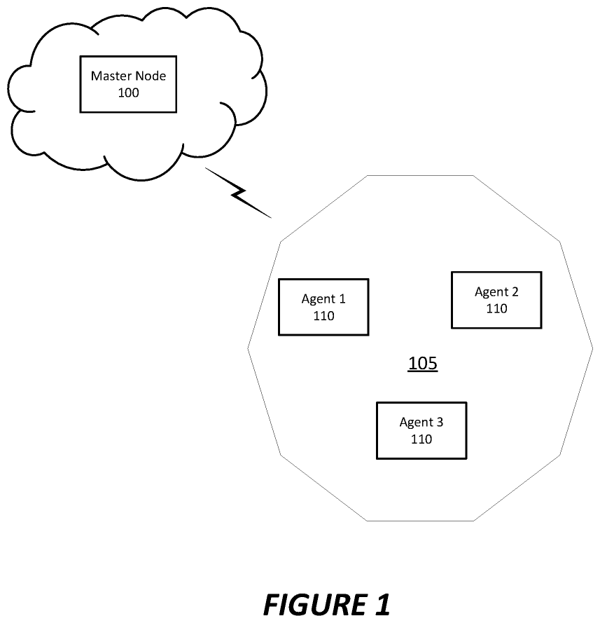

A multi-agent RL system is illustrated in FIG. 1. As shown therein, a plurality of agents 110, namely, Agent 1, Agent 2 and Agent 3, operate within an environment 105. The agents 110 may be, for example, robots operating within a manufacturing facility environment, base station nodes operating within a wireless communication system environment, etc. Each agent 110 makes an observation of the environment 105 and, in response to the observation, takes an action in the environment 105 according to a policy which causes the state of the agent 110 to change. Each agent 110 receives a reward based on the action it takes, and updates its policy based on the reward and the new state. The objective of each agent 110 is to find an optimal policy that maximizes the reward obtained from the environment 105. The multi-agent reinforcement learning operation may be managed by a master node 100 that may or may not also be present within the environment 105. For example, the master node 100 may be cloud-based as shown in FIG. 1.

In general, there are two approaches to solving multi-agent RL problems, namely a sequential approach and a simultaneous approach. In a sequential approach, the agents 110 operate sequentially to achieve the common goal. That is, in a current time step, one agent individually solves its own state. In the next time step another agent solves its own state conditionally dependent on the previous state. This process repeats sequentially for each agent.

There are two steps to be performed at each time step, namely, policy computation and policy execution. In the policy computation step, the agent observes the state of the environment and the reward received in response to a previous action and updates the policy based on the state and the reward. In DQN, this involves updating Q-values based on a current sample. In the policy execution step, the agent executes the policy. In a sequential approach, a single agent performs both policy computation and policy execution in a given time step.

An advantage of this approach is that it is computationally less intensive. However, a sequential approach may take more time to converge and the policy obtained may not be globally optimal. Also, a sequential approach is prone to non-stationarity and may be unsuitable for DQN techniques, as replay buffers do not stabilize. Non-stationarity means that the same results may not be obtained depending on the order in which agents solve their states. Non-stationarity arises because observations by one agent may become corrupted or out of date when a previous agent performs an action on the environment.

In a simultaneous approach, all agents perform policy computation and execution in a single time step. Using this approach, the overall solution can be globally optimal under some conditions. However, the simultaneous approach is computationally complex and may take more time to compute.

Some embodiments described herein provide a method in which policy execution is performed simultaneously, but policy computation is performed sequentially in order of agent reliability. Some embodiments described herein may be solved without reduced computational cost compared to conventional simultaneous methods. In addition, some embodiments account for the non-stationarity and credit assignment problems encountered by naïve decentralized methods.

In most cases, the underlying MDP of the system is stochastic, and hence determining the distribution over the actions conditioned by actions of other agents is not a trivial task. This can introduce even more non-stationarity in the problem and the convergence time using DQN methods may be very long.

Some embodiments described herein use a ranking-based mechanism to solve this problem. The agents of the system are ranked based on a measure of randomness of their individual MDPs. The policies of agents with lower randomness in their MDP are computed first followed by the other agents in descending order of MDP randomness. The environment of the other agents is conditioned on the action taken by the preceding agent. This helps to ensure that the execution and state transition on which the policy computations rely can be guaranteed with higher probability.

This approach may result in faster convergence to a global optimum policy in reduced computational time. This is because ranking the agents in terms of random probability of their MDPs and conditioning the actions of each agent based on state-transition of preceding agents may reduce the uncertainty as seen in the global environment and aid in quicker and more accurate convergence.

The combined optimization problem (which is complex) is thereby cast as a greedy optimization problem that can be solved easily. An added advantage of the embodiments described herein is that the MDP model of the individual agents are computed without being supplied by a user.

In an RL process, the underlying system is assumed to be Markov Decision Process (MDP). In an MDP, it is assumed that the state of the system at a current instant (sₜ) depends on the previous state of the system (sₜ₋₁). The aim of the RL agent is to perform actions that move the system from one state to another state which yields a higher reward in both a shorter time frame as well as a longer time frame. However, the choice of the action does not mean the system will transition to another state. That is, the relationship between an action and an expected state transition is stochastic.

For example, assume that in one time instant the agent performs an action a₁ when the system is in state s₁, and in response to the action the system transitions to state s₂. In another time instant, if the agent performs the same action a₁, the system will not necessarily transition to state s₂. The state transition of the system depends on the stochasticity of the total MDP of the underlying process.

If the stochasticity of the system is low, meaning that the system is well behaved, then given the same initial state, the system will be more likely to transition to the same state when the same action is performed. In a multi-agent scenario, this is an important consideration, since the agents may, according to some embodiments, be chosen to update their policies based on the underlying MDP probability.

In some embodiments, the MDP process probability is used to identify which agent is solved first and the remaining agents are arranged in a ranked fashion according to ascending variability of their underlying MDPs. First, the agents with lower MDP variability are solved, which results in those agents being more likely to receive a higher reward, and followed by agents with higher MDP variability but conditioned on actions of a preceding agent. In this way, the agents in the multi-agent RL scenario are solved.

In the following example, it is assumed that there are N agents in the system, each of which has an action space a_{P}. That is, each agent can select an action from an action space a_{P}={a₁, a₂ . . . a_{P}}. Similarly, the system has a state space is S_{M}.

The steps of the method according to some embodiments may be coordinated/controlled by a master node are as follows:
1. Assume a random ranking of the N agents, e.g., r={A₂, Aᵢ, . . . , A_{N} . . . , A₁}.
2. At each time step, the following steps are performed:
   a. The RL problem is solved by solving the following function for the first ranked agent A₂ selected in previous step. The loss function in the Deep RL is (Q_{actual}−Q_{pred})², where

Q_{actual}={rₜ₊₁+γₐ_{ₜ₊₁}^{max}Q(sₜ₊₁, aₜ₊₁)}, Q_{pred}=ƒ(θ, sₜ)
where θ represents the parameters of the network.
b. Based on the computed state of A₂ from the previous step, the next agent problem Aᵢ is solved conditioned on the solution reached for the previous agent. The new deep RL loss function is

Q_{actual}={rₜ₊₁+γₐ_{ₜ₊₁}^{max}Q(sₜ₊₁, aₜ₊₁)}, Q_{pred}=ƒ(θ, {s_{A}_{₂}, s_{A}_{ᵢ}})
That is, the reward function computation is tuned based on the previous agent's state, which in this example is agent A₂.
c. This process is repeated for all the agents in an ordered fashion conditioned on previous agent's state.
3. At the end of the previous step, the states of all agents and their corresponding actions are computed.
4. Next, the agents simultaneously perform the selected actions and calculate the resulting rewards.
5. The expected transitioned states and actual transitioned states obtained are monitored. For example, assume the expected transitioned state is S_{E}, whereas in the real environment the actual state obtained is sₐ. Based on this observation, a master agent counts the estimated probability of transition. To do this, a counter is defined for each agent, and the counter is updated at each time step. If the expected and actual states observed by an agent are the same, the counter is incremented by 1; otherwise, the counter remains the same as its previous value.
6. The value of the counter is averaged by dividing it with the number of elapsed time steps to obtain a normalized value. In this manner, a normalized value is computed for each agent that represents the variability of its underlying MDP, namely, the higher the normalized value, the lower the variability of the MDP (i.e., the more predictable the state transition will be for the agent given a previous state and a selected action).
7. The agents are then arranged in terms of the normalized counter value from higher value to lower value. Steps 2-6 are then repeated until convergence.

In this manner, the multi-agent RL problem can be solved such that all the agents outputs are solved simultaneously. The conditional dependencies between agents can be monitored using a neural network.

As an example, assume there are three agents A₁, A₂, A₃ interacting with an environment. Assume further the current local states of the agents are {s₁₁, s₂₁, s₃₁}. The embodiments described herein may be implemented in two phases, namely a policy computation/update phase and a policy execution phase.

### Policy Computation/Update

In this phase, the actions of the three agents are computed, but will not be executed yet. Initially, a random ranking is assumed for the agents, e.g., assume the agents are ranked {1,2,3}. According to this ranking, the policies for the agents will be solved in order as agent 1, then agent 2 and finally agent 3.

The policy computation for Agent 1 will be independent of all the agents which is (since it is ranked 1):

Agent₁—→π₁ᵢ(a|s₁₁)=a₂ transitioned to s₁₂

Here, the policy computed assumes the action is computed assuming the agent observing environment will transition to s₁₂, when in reality it may not.

The policy computation for Agent 2 will be dependent on the outcome of the computation for Agent 1:

Agent₂—→π₂ᵢ(a|s₂₁, s₁₂(future state of agent 1))=a₁ transitioned to s₂₂

Likewise the policy computation for Agent 3 will be depend on the outcomes of the computations for Agent 1 and Agent 2:

$${Agent}_{3} -- - \to {π}_{3 i} ( a \vert {s}_{31} , {s}_{12} ( future state of agent 1 ) , {s}_{22} ( ( future state of agent 2 ) )$$

$$= {a}_{2} transitioned to {s}_{32}$$

### Policy Execution

In this phase, the actions computed in the previous step are executed in the real environment. For example from the previous step it was predicted that the agents will transition to the states {s_12,s_22,s_32}. In reality, because of the stochastic nature of the process the actual state transitions may be different.

The actual state transitions for each agent are compared with the expected state transitions, and the counter for each agent will then be updated based a comparison of the expected state transition and actual state transition. The agents are then ranked based on the counter values, where a higher counter value for an agent signifies that its underlying MDP process has a higher transition probability, i.e. is less random.

These steps are then repeated until convergence or until the rankings of the agents do not change between iterations.

An example use case for the above-described multi-agent RL approach is management and operation of a telecommunications network. A telecommunications network has many different parameters which can be varied to affect global performance of the network.

Within the network, a set of local agents (such as base stations) work together to achieve one or more global targets, such as key performance indicators (KPIs). Example KPIs may include throughput, energy efficiency and coverage of the network. These goals may be achieved by tuning the behavior of the agents using a multi-agent RL approach as described above.

Further, the policy may be formulated as a deep RL problem with two fully connected layers. Initially, the agents are run for some time without worrying about the performance of the global system. The resulting state/action/reward information <sₜ, aₜ, rₜ, sₜ₊₁> is stored in a database.

For each agent, the action space is discretized into two spaces whether increase/decrease. Similarly, the state space is represented by a quality of service (QoS) metric. The QoS may be discretized into a discrete number (e.g., 3) intervals for easy computation.

Initially, the three agents will start running the process. First, ranks of the three agents are randomly assigned. For example, the initial order of the agents may be {2,1,3}. The counters for all the agents are initialized to zero.

Next, the next state of Agent 2 is solved first independently of the other agents. The next state of Agent 1 is then solved conditioned on the output of Agent 2, and then the next state of Agent 3 is solved conditioned on the outputs of Agent 2 and Agent 1. All these calculations can occur in the same time step, and after that the selected actions are performed.

Next, the agents' counters are updated based on whether the actual state transition matches the expected state transition for each agent. That is, if the expected next state of an agent is same as the actual next state after performing the selected action, the counter of the agent is incremented by 1, and if not, the counter is not incremented. The counters are then averaged by dividing by the number of elapsed time steps since the counters were reset, and the agents are ranked based on decreasing order of the counters. That is, the rankings of agents are updated based on the counters such that agents with lower process variability are ranked ahead of agents with higher process variability.

The process is then repeated, for example, until the agent rankings converge.

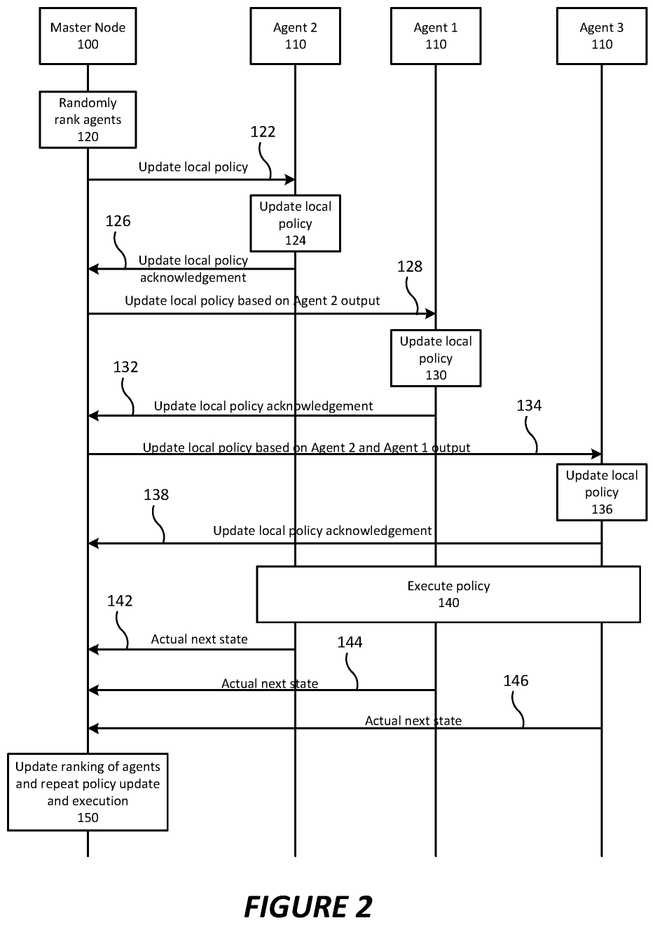

FIG. 2 illustrates the operation of agents in a multi-agent RL system according to some embodiments. In particular, an RL system includes a master node 100 and a plurality of agents 110 ((i.e., Agent 1, Agent 2 and Agent 3).

Referring to FIG. 2, the master node 100 randomly ranks agents for performing sequential policy updates. The master node 100 then sequentially instructs the agents 110 to update their local policies. For example, the master node 100 sends an instruction 122 to the first ranked agent (Agent 2) instructing Agent 2 to update its local policy.

Because Agent 2 is the first selected agent, it performs its policy update (block 124) independent of the policy updates of other agents. Agent 2 then transmits an acknowledgement 126 of the update instruction to the master node 100 along with the results of the update, namely, the expected next state of Agent 2 based on an action selected in accordance with the updated policy of Agent 2.

Next, the master node 100 sends an instruction 128 to the next ranked agent (Agent 1) instructing Agent 1 to update its local policy based on the output from Agent 2, the previously selected agent. In particular, the master node 100 instructs Agent 1 to update its local policy based at least in part on the expected next state of Agent 2 calculated in block 124 above.

Agent 1 then updates is local policy based on the expected next state of Agent 2 (block 130), and sends its output including its expected next state to the master node 100 in an acknowledgement message 132.

Next, the master node 100 sends an instruction 134 to the next ranked agent (Agent 3) instructing Agent 3 to update its local policy based on the outputs from Agent 2 and Agent 1, the previously selected agents. In particular, the master node 100 instructs Agent 3 to update its local policy based at least in part on the expected next states of Agent 2 and Agent 1 calculated in blocks 124 and 130 above.

Agent 3 then updates is local policy based on the expected next states of Agent 2 and Agent 1 (block 136), and sends its output including its expected next state to the master node 100 in an acknowledgement message 138.

All three agents then execute the action selected in accordance with their updated policy simultaneously (i.e., within the same time step) at block 140. The agents then determine their actual next states, i.e., the states to which they transitioned after executing the selected actions, and send their actual next states to the master node 100 in messages 142-146. Using the expected and actual state transitions of the agents, the master node 100 then calculates the relative variability of the stochastic processes underlying the behavior of the agents as described above, and updates the ranking of the agents based on the calculated variability (block 150). The process then repeats by sequentially updating the local policies of the agents and simultaneously performing the actions selected based on the updated policies.

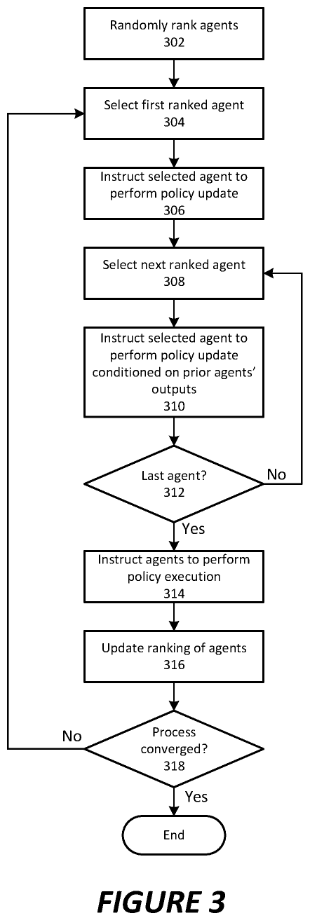

FIG. 3 is a flowchart of operations of a master node 100. In particular, FIG. 3 illustrates a method of performing multi-agent reinforcement learning in a system including a plurality of agents 110 that execute actions on an environment based on respective local policies of the agents. The method includes ranking the agents 110 (316) based on estimated levels of variability of stochastic processes underlying the behavior of respective ones of the plurality of agents, selecting (304) a first ranked agent, i.e., an agent having a lowest level of variability of its underlying stochastic process, instructing (306) the selected agent to update its local policy, select an action based on its updated local policy, and generate an expected next state based on the selected action, and repeatedly selecting a next agent (308) having a next lowest level of variability of its underlying stochastic process and instructing (310) the next selected agent to update its local policy based on previously generated expected next states of previously selected agents, select an action based on its updated local policy, and generate an expected next state based on the selected action.

The method may further include initially generating (302) a random ranking of the plurality of agents.

The method may further include instructing the agents to execute the selected actions.

The method may further include determining actual next states of the agents after executing the selected actions, comparing the actual next states of the agents after executing the selected actions to the expected next states of the agents, and generating a ranking of the agents by variability of their underlying stochastic processes based on the comparison of the actual next states of the agents after executing the selected actions to the expected next states of the agents.

The method may further include, for each agent, incrementing a counter when the expected next state of the agent matches the actual next state of the agent, wherein the ranking of the agents by variability of their underlying stochastic processes is based on values of their respective counters.

The method may further include normalizing the counter values by dividing the counter values by a number of elapsed time steps since the counters were started.

The method may further include iteratively updating a ranking of the agents based on variability of their underlying stochastic processes, sequentially updating local policies of the agents, and simultaneously executing selected actions based on the updated local policies until the ranking of agents does not change between successive iterations.

The underlying stochastic processes of the agents may be Markov Decision Processes.

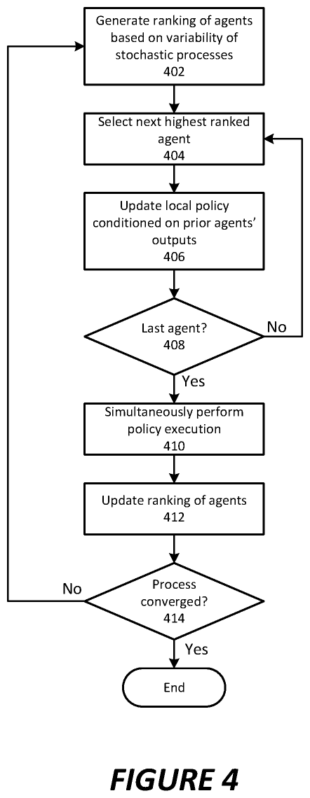

FIG. 4 illustrates a method of performing multi-agent reinforcement learning in a system including a master node 100 and a plurality of agents 110 that execute actions on an environment based on respective local policies of the agents. The method includes generating (402) a ranking of the plurality of agents based on levels of variability of stochastic processes underlying the behavior of respective ones of the plurality of agents, sequentially updating (406) the local policies of the agents in order based on the ranking, wherein the local policy of a selected agent is updated conditioned on an expected next state of at least one previously selected agent, simultaneously executing actions (410) by agents based on their updated local policies, and updating (412) the ranking of the plurality of agents in response to executing the actions.

Updating the rankings of the agents may include updating a counter for each agent after executing the actions, wherein the counter for an agent is incremented when an actual next state of the agent after executing the action matches an expected next state of the agent.

The method may further include normalizing the counter values by dividing the counter values by a number of elapsed time steps since the counters were started.

Updating the local policy of an agent may include selecting an action based on an updated local policy of the agent, and generating an expected next state based on the selected action.

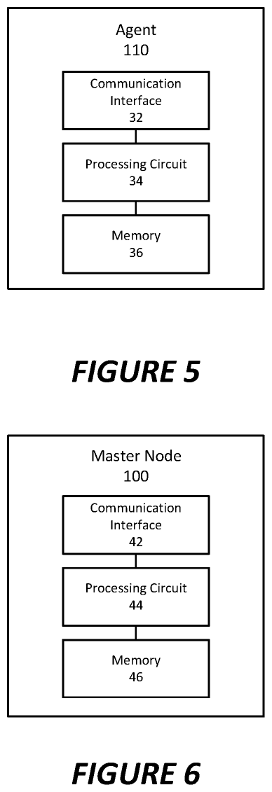

FIG. 5 is a block diagram of a device, such as an agent 110. Various embodiments provide a device 110 that includes a processor circuit 34 a communication interface 32 coupled to the processor circuit, and a memory 36 coupled to the processor circuit 34. The memory 36 includes machine-readable computer program instructions that, when executed by the processor circuit, cause the processor circuit to perform some of the operations depicted described herein.

As shown, the agent 110 includes a communication interface 32 (also referred to as a network interface) configured to provide communications with other devices. The agent 110 also includes a processor circuit 34 (also referred to as a processor) and a memory circuit 36 (also referred to as memory) coupled to the processor circuit 34. According to other embodiments, processor circuit 34 may be defined to include memory so that a separate memory circuit is not required.

As discussed herein, operations of the agent 110 may be performed by processing circuit 34 and/or communication interface 32. For example, the processing circuit 34 may control the communication interface 32 to transmit communications through the communication interface 32 to one or more other devices and/or to receive communications through network interface from one or more other devices. Moreover, modules may be stored in memory 36, and these modules may provide instructions so that when instructions of a module are executed by processing circuit 34, processing circuit 34 performs respective operations (e.g., operations discussed herein with respect to example embodiments).

FIG. 6 is a block diagram of a master node 100 to which a computation task may be offloaded. Various embodiments provide a master node 100 that includes a processor circuit 44 a communication interface 42 coupled to the processor circuit, and a memory 46 coupled to the processor circuit 44. The memory 46 includes machine-readable computer program instructions that, when executed by the processor circuit, cause the processor circuit to perform some of the operations depicted described herein.

As shown, the master node 100 includes a communication interface 42 (also referred to as a network interface) configured to provide communications with other devices. The master node 100 also includes a processor circuit 44 (also referred to as a processor) and a memory circuit 46 (also referred to as memory) coupled to the processor circuit 44. According to other embodiments, processor circuit 44 may be defined to include memory so that a separate memory circuit is not required.

As discussed herein, operations of the master node 100 may be performed by processing circuit 44 and/or communication interface 42. For example, the processing circuit 44 may control the communication interface 42 to transmit communications through the communication interface 42 to one or more other devices and/or to receive communications through network interface from one or more other devices. Moreover, modules may be stored in memory 46, and these modules may provide instructions so that when instructions of a module are executed by processing circuit 44, processing circuit 44 performs respective operations (e.g., operations discussed herein with respect to example embodiments).

Referring to FIGS. 3 and 6, a master node (100) for controlling multi-agent reinforcement learning configured to perform operations including estimating (316) levels of variability of stochastic processes underlying the behavior of respective ones of the plurality of agents, selecting (304, 308) an agent having a lowest level of variability of its underlying stochastic process, instructing (306, 310) the selected agent to update its local policy, select an action based on its updated local policy, and generate an expected next state based on the selected action, and repeatedly selecting (308) a next agent having a next lowest level of variability of its underlying stochastic process and instructing the next selected agent to update its local policy based on previously generated expected next states of previously selected agents, select an action based on its updated local policy, and generate an expected next state based on the selected action.

Referring to FIGS. 3 and 6, a master node (100) for controlling multi-agent reinforcement learning according to some embodiments includes a processing circuit (34), and a memory (36) coupled to the processing circuit, wherein the memory comprises computer readable program instructions that, when executed by the processing circuit, cause the computing device to perform operations of estimating (316) levels of variability of stochastic processes underlying the behavior of respective ones of the plurality of agents, selecting (304, 308) an agent having a lowest level of variability of its underlying stochastic process, instructing (306, 310) the selected agent to update its local policy, select an action based on its updated local policy, and generate an expected next state based on the selected action, and repeatedly selecting (308) a next agent having a next lowest level of variability of its underlying stochastic process and instructing the next selected agent to update its local policy based on previously generated expected next states of previously selected agents, select an action based on its updated local policy, and generate an expected next state based on the selected action.

Some embodiments provide a computer program comprising program code to be executed by processing circuitry (34) of a computing device (100), whereby execution of the program code causes the computing device (100) to perform operations of estimating (316) levels of variability of stochastic processes underlying the behavior of respective ones of the plurality of agents, selecting (304, 308) an agent having a lowest level of variability of its underlying stochastic process, instructing (306, 310) the selected agent to update its local policy, select an action based on its updated local policy, and generate an expected next state based on the selected action, and repeatedly selecting (308) a next agent having a next lowest level of variability of its underlying stochastic process and instructing the next selected agent to update its local policy based on previously generated expected next states of previously selected agents, select an action based on its updated local policy, and generate an expected next state based on the selected action.

A computer program product according to some embodiments includes a non-transitory storage medium including program code to be executed by processing circuitry (34) of a computing device (100), whereby execution of the program code causes the computing device to perform operations of estimating (316) levels of variability of stochastic processes underlying the behavior of respective ones of the plurality of agents, selecting (304, 308) an agent having a lowest level of variability of its underlying stochastic process, instructing (306, 310) the selected agent to update its local policy, select an action based on its updated local policy, and generate an expected next state based on the selected action, and repeatedly selecting (308) a next agent having a next lowest level of variability of its underlying stochastic process and instructing the next selected agent to update its local policy based on previously generated expected next states of previously selected agents, select an action based on its updated local policy, and generate an expected next state based on the selected action.

Some embodiments provide a computer program comprising program code to be executed by processing circuitry of a computing device, whereby execution of the program code causes the computing device to perform operations including generating (402) a ranking of a plurality of agents in a multi-agent reinforcement learning system including a master node based on levels of variability of stochastic processes underlying the behavior of respective ones of the plurality of agents, sequentially selecting (404) the agents in order based on the ranking and updating their local policies, wherein the local policy of a selected agent is updated conditioned on an expected next state of at least one previously selected agent; simultaneously (410) executing actions by agents based on their updated local policies; and updating (412) the ranking of the plurality of agents in response to executing the actions.

Some embodiments provide a computer program product comprising a non-transitory storage medium including program code to be executed by processing circuitry of a computing device, whereby execution of the program code causes the computing device to perform operations including generating (402) a ranking of a plurality of agents in a multi-agent reinforcement learning system including a master node based on levels of variability of stochastic processes underlying the behavior of respective ones of the plurality of agents, sequentially selecting (404) the agents in order based on the ranking and updating their local policies, wherein the local policy of a selected agent is updated conditioned on an expected next state of at least one previously selected agent; simultaneously (410) executing actions by agents based on their updated local policies; and updating (412) the ranking of the plurality of agents in response to executing the actions.

### Abbreviations

AGV Automated Guided Vehicle
QoS Quality of Service
KPI Key Performance Indicator
RTT Round-Trip Time
DRL Deep Reinforcement Learning
DQN Deep Q-Network (DRL algorithm)
CEM Cross-Entropy Method (DRL algorithm)
SARSA State-Action-reward-State-Action (DRL algorithm)
NIC Network Interface Card
LIDAR Light Detection and Ranging

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of performing multi-agent reinforcement learning in a system including a plurality of agents that execute actions on an environment based on respective local policies of the agents, the method comprising:
estimating levels of variability of stochastic processes underlying the behavior of respective ones of the plurality of agents;
selecting an agent having a lowest level of variability of its underlying stochastic process;
instructing the selected agent to update its local policy, select an action based on its updated local policy, and generate an expected next state based on the selected action; and
repeatedly selecting a next agent having a next lowest level of variability of its underlying stochastic process and instructing the next selected agent to update its local policy based on previously generated expected next states of previously selected agents, select an action based on its updated local policy, and generate an expected next state based on the selected action.

2. The method of claim 1, further comprising:
initially generating a random ranking of the plurality of agents.

3. The method of claim 2, further comprising:
instructing the agents to execute the selected actions.

4. The method of claim 3, further comprising:
determining actual next states of the agents after executing the selected actions;
comparing the actual next states of the agents after executing the selected actions to the expected next states of the agents; and
generating a ranking of the agents by variability of their underlying stochastic processes based on the comparison of the actual next states of the agents after executing the selected actions to the expected next states of the agents.

5. The method of claim 4, further comprising:
for each agent, incrementing a counter when the expected next state of the agent matches the actual next state of the agent;
wherein the ranking of the agents by variability of their underlying stochastic processes is based on values of their respective counters in ascending order.

6. The method of claim 5, further comprising:
normalizing the counter values by dividing the counter values by a number of elapsed time steps since the counters were started.

7. The method of claim 1, further comprising iteratively updating a ranking of the agents based on variability of their underlying stochastic processes, sequentially updating local policies of the agents, and simultaneously executing selected actions based on the updated local policies until the ranking of agents does not change between successive iterations.

8. The method of claim 5, wherein the underlying stochastic processes of the agents comprise Markov Decision Processes.

9. A master node for controlling multi-agent reinforcement learning configured to perform operations according to claim 1.

10. A master node for controlling multi-agent reinforcement learning, comprising:
a processing circuit; and
a memory coupled to the processing circuit, wherein the memory comprises computer readable program instructions that, when executed by the processing circuit, cause the computing device to perform operations according to claim 1.

11. A computer program comprising program code to be executed by processing circuitry of a computing device, whereby execution of the program code causes the computing device to perform operations according claim 1.

12. A computer program product comprising a non-transitory storage medium including program code to be executed by processing circuitry of a computing device, whereby execution of the program code causes the computing device to perform operations according to claim 1.

13. A method of performing multi-agent reinforcement learning in a system including a master node and a plurality of agents that execute actions on an environment based on respective local policies of the agents, the method comprising:
generating a ranking of the plurality of agents based on levels of variability of stochastic processes underlying the behavior of respective ones of the plurality of agents;
sequentially selecting the agents in order based on the ranking and updating their local policies, wherein the local policy of a selected agent is updated conditioned on an expected next state of at least one previously selected agent;
simultaneously executing actions by agents based on their updated local policies; and
updating the ranking of the plurality of agents in response to executing the actions.

14. The method of claim 13, wherein updating the rankings of the agents comprises updating a counter for each agent after executing the actions, wherein the counter for an agent is incremented when an actual next state of the agent after executing the action matches an expected next state of the agent.

15. The method of claim 14, further comprising:
normalizing the counter values by dividing the counter values by a number of elapsed time steps since the counters were started.

16. The method of claim 13, wherein updating the local policy of an agent comprises selecting an action based on an updated local policy of the agent, and generating an expected next state based on the selected action.

17. The method of claim 13, further comprising:
initially generating a random ranking of the agents.

18. (canceled)

19. A computer program product comprising a non-transitory storage medium including program code to be executed by processing circuitry of a computing device, whereby execution of the program code causes the computing device to perform operations according to claim 13.
